(19) United States
(12) Patent Application Publication
(10) Pub. No.: US 2009/0113525 A1
(43) Pub. Date: Apr. 30, 2009

(54) System and Method for Providing Secure Access to Wireless Wide Area Networks

(76) Inventors: Ashok Sunder Rajan, (US); Deepak Jain, Garland, TX (US)

Correspondence Address: THE JANSSON FIRM, 9501 N. CAPITAL OF TX HWY #202, AUSTIN, TX, 78759, US

(21) Appl. No.: 11/931,705

(22) Filed: Oct. 31, 2007

(51) Int. Cl. G06F 7/04

(52) U.S. Cl. 726/4

(57) ABSTRACT

A subscriber station with a secure element and an access control system combine to permit secure connections to a Wide Area Network, and to the terminal equipment within a customer premises network. A removable secure element provides a simplified upgradeability and portability of credentials to new hardware. Also, a terminal equipment device that does not have the ability to connect to the Wide Area Network gains the ability to connect to the Wide Area Network through any subscriber station with a secure element.

### TECHNICAL FIELD

The present invention relates generally to connecting devices to a wireless network and more particularly to a device and method for authentication of terminal equipment to a wireless subscriber station.

### BACKGROUND OF THE INVENTION

Wireless networks have typically provided either long-range mobile access (e.g., cellular telephone networks) or high bandwidth fixed access (e.g., short distance WiFi networks). The IEEE 802.16 Broadband Wireless Access Standard for Local and Metropolitan Area Networks defines high bandwidth/long-range (10 Mbps at 10 km) wireless networks in both fixed and mobile applications. The 802.16f and 802.16e standards define two types of terminal devices: Subscriber Stations (SS) and Mobile Stations (MS). The 802.16d standard defines the fixed wireless broadband access technology that interconnects the elements of the Local and Metropolitan Area Networks over licensed spectra. The entire contents of the IEEE 802.16d, 802.16e and 802.16f standards are herein incorporated by reference. Both Subscriber Stations and Mobile Stations may connect to a Network Access Provider (NAP) that has access to a Wide Area Network (WAN) such as the Internet. The Subscriber Station is a stationary device that connects to the Wide Area Network (WAN) over the 802.16d fixed wireless access technology standard. The Subscriber Station is registered to the subscriber's account by the network operator, and works as an Access Point to permit end users with various types of Terminal Equipment (TE) to establish a local network called a Customer Premises Networks (CPN). The Customer Premises Network can be implemented through either wireless or wired LAN technologies (e.g., 802.11 Wireless LAN or 802.3 Ethernet LAN). The Mobile Station can act as a Terminal Equipment device, gaining access to the Wide Area Network through the Subscriber Station's 802.16 wireless access technology or the Mobile Station can connect directly to the Wide Area Network through its own 802.16 mobile wireless access technology, like a Subscriber Station. While a Subscriber Station must be registered to a network operator, there is no such requirement for Terminal Equipment devices. Mobile Stations, however, must be registered to a subscription account with the network operator in order to gain direct access to the Wide Area Network through its own 802.16 mobile wireless access technology. However, unlike Subscriber Stations that typically connect to a specific Network Access Provider, a Mobile Station is a portable device that can connect to multiple Network Access Providers or Subscriber Stations. In the future, the IEEE 802.20 Working Group for Mobile Broadband Wireless Access and IEEE 802.22 Working Group for Wireless Regional Area Networks and all other long-range wireless standards will extend the range and capabilities of wireless access.

Currently, wireless enabled devices such as laptop computers connect to a wireless router following, e.g., the 802.11 Wireless LAN standard. Such wireless routers are purchased at electronics retail stores, are connected to the Internet through an Internet Service Provider (ISP) and typically come out of the box with no security features enabled, permitting open access to the resources in the Wireless LAN to anybody with a wireless enabled device. As such, foreign devices may free ride on the network resources of the owner of the wireless router. Particularly in densely populated areas such as apartment complexes or residential neighborhoods, a user with wireless devices, e.g., laptop computers, may simply search the airwaves for unsecured wireless routers and obtain all the benefits of access to the Internet that the wireless router owners pay for, without incurring any cost to themselves. As a result, ISP operators lose revenue from stolen bandwidth. Network operators also suffer network bandwidth and traffic dimensioning problems. Finally, this open access threatens the security of every device legitimately on the network, as open access leaves all devices on a network susceptible to a virus attack by the unauthorized user. These risks are limited in geographic scope under the 802.11 Wireless LAN standard because connection ranges are typically less than 100 meters. With the widespread implementation of the 802.16 and other future wireless standards, the potential risk from these problems is exacerbated because their wider range, portability and mobility enables a much wider device eco-system, and permits many more wireless devices to attempt to free-ride on the licensed network. Furthermore, while unauthorized wireless network access is a nuisance to Access Point owners and network operators under the 802.11 Wireless LAN standard, such unauthorized access is totally unacceptable when considering present and future licensed spectra standards like 802.16, 802.20, 802.22 and all other long-range wireless standards.

These problems are typically overcome under the 802.11 Wireless LAN standard when the Access Point owner enables the security features of the Access Point. Such security features include disabling the broadcasting of the Access Point name over the airwaves to prevent unauthorized users from seeing the device, MAC address filtering which prevents devices with unknown MAC addresses from gaining access to network resources, and log-on authentication. However, these measures severely limit the flexibility and negatively impact the mobility afforded by having wireless enabled devices. The wireless enabled device owner must know of the existence of a wireless Access Point at each location where they wish to gain access, negotiate with the owner of that Access Point to add their device to the permitted MAC address list and in some cases, purchase multiple log-on authentication accounts to gain access to the network. For these reasons, such security features are incompatible with the goals of the 802.16 Broadband Wireless Access Standard for Local and Metropolitan Area Networks to provide greater mobility and ease of use.

Additionally, wireless Access Points under the 802.11 Wireless LAN standard typically do not connect directly to the Wide Area Network, but rather they are hard-wired to a broadband modem that is, itself, connected to the Wide Area Network through, e.g., a corporate ISDN network or broadband Internet Service Provider (ISP). On the other hand, a Subscriber Station uses its 802.16 wireless access technology to connect directly to the Wide Area Network through a Base Station (BS) operated by the Network Access Provider. Further, a Mobile Station can move between the Customer Premises Network and the Wide Area Network, i.e., the Mobile Station can connect as Terminal Equipment device behind the 802.16 access provided by the Subscriber Station within the Customer Premises Network, or the Mobile Station can connect directly to the Wide Area Network through its own 802.16 mobile wireless access technology to either a Subscriber Station or a Base Station. As such, Mobile Stations present unique problems with managing registration onto the Wide Area Network under its own subscription account.

Finally, under the 802.11 Wireless LAN standard, Terminal Equipment devices do not carry any registration or provisioning information with them when they move from an area served by one Access Point to an area served by another Access Point. As such, the owner of the Terminal Equipment device must separately provision and create a registration profile for each Access Point where the Terminal Equipment owner wishes to gain access to the Wide Area Network. This problem is exacerbated by the fact that the owner of the Access Point may choose not to permit the Terminal Equipment device onto the network served by the Access Point. This highlights the need for an improved method of transporting registration information in a Terminal Equipment device transparently from one Access Point to another

From the foregoing it will be apparent that there is a need for improved methods of ensuring that only registered device owners have access to the network resources of a Network Access Provider, and of maintaining secure access to local area network resources while permitting greater mobility of wireless enabled devices.

### BRIEF DESCRIPTION OF THE DRAWINGS

FIG. 1 is a schematic illustration of a Wide Area Network wirelessly connected to a Mobile Station and a Subscriber Station and Terminal Equipment devices connected to the Subscriber Station to form a Customer Premises Network.

FIG. 2 is a functional view of a Subscriber Station according to one embodiment of the present invention.

FIG. 3 is a functional view of a Secure Element in a Subscriber Station according an embodiment of the present invention.

FIG. 4 is a functional view of the data stored in the non-volatile memory of the Secure Element of the present invention.

FIG. 5 is a functional view of the programs residing on the ROM of the Subscriber Station of the present invention.

FIG. 6A-B is a flow-chart of the functional interactions between the various parts of the Subscriber Station of the present invention.

FIG. 7 is a schematic illustration of a Security Enabled Terminal Equipment device with the ability to connect to the Wide Area Network through either a Home Subscriber Station or a Foreign Subscriber Station.

FIG. 8 is a functional view of a Secure Element in a Security Enabled Terminal Equipment device according to an embodiment of the present invention.

FIG. 9 is a functional view of the data stored in the non-volatile memory of the Secure Element in a Security Enabled Terminal Equipment device of the present invention.

FIG. 10 is a flow-chart of the functional interactions between the Home Subscriber Station, the Foreign Subscriber Station and the Security Enabled Terminal Equipment.

FIG. 11 is a schematic illustration of a laptop computer that is enabled to function as a Subscriber Station with a Secure Element as described in the present invention.

FIG. 12 is a functional view of an Enhanced Secure Element according to an embodiment of the present invention.

FIG. 13 is a functional view of a laptop computer that is enabled to function as a Subscriber Station with an Enhanced Secure Element as described in the present invention.

FIG. 14 is a functional view of a dongle that creates a Subscriber Station of any device that it is plugged in to according to an embodiment of the present invention.

FIG. 15A-C is a flow chart summarizing the functional features of the present invention.

### DETAILED DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The IEEE 802.16 Broadband Wireless Access Standard for Local and Metropolitan Area Networks represents the current standard for long-range wireless standards, and is used herein for illustrative purposes. The present invention is not limited by precise implementation details of the long-range wireless connections, which compose a wireless access network. The present invention applies to any wireless standard that requires secure access and user authentication. Any reference to IEEE 802.16 may be replaced with IEEE 802.20, IEEE 802.22 or other unspecified wireless network standards without changing the nature of this disclosure.

### INTRODUCTION

As shown in the drawings for the purposes of illustration, a subscriber station with a secure element and an access control system combine to permit secure connections to a Wide Area Network, and the terminal equipment within a customer premises network. Such a system solves the problems associated with the increasing demand for secure and portable access to Wide Area Networks. Additionally, such a system provides simplified upgradeability and portability of credentials to new hardware. Also, a terminal equipment device that does not have the ability to connect to the Wide Area Network gains the ability to connect to the Wide Area Network through any subscriber station with the present invention.

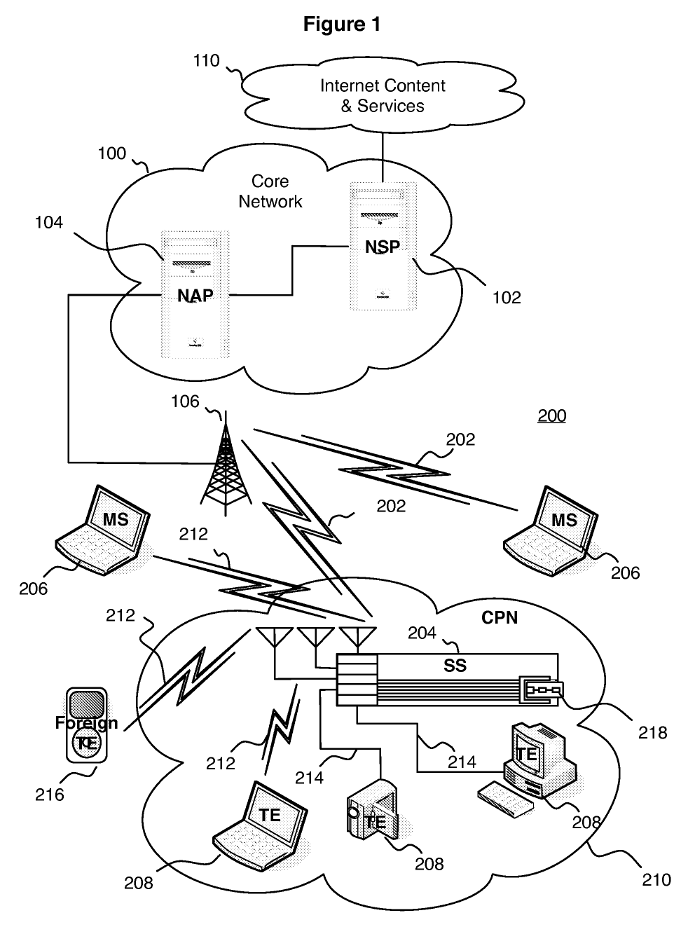

FIG. 1 shows a Wide Area Network (WAN) 200 connected to the Core Network (CN) 100. The Core Network 100 typically includes the services of a Network Service Provider (NSP) 102 that manages access to the Internet content and services 110 and a Network Access Provider (NAP) 104 that maintains a network of Base Stations (BS) 106 for the distribution of their services. The Network Access Provider 104 is connected through the Base Stations 106 with the Wide Area Network 200 through long-range wireless connections 202 in accordance with, e.g., the IEEE 802.16 specification. The Wide Area Network 200 includes stationary access devices 204 called Subscriber Stations (SS) and mobile access devices 206 called Mobile Stations (MS). Various types of devices 208 called Terminal Equipment (TE) connect to the Subscriber Station 204 to form a Customer Premises Network (CPN) 210. Connections within the Customer Premises Network are either wireless connections 212 or hardwired connections 214. Wired connections may include, but are not limited to, Ethernet, USB or Firewire. Examples of wireless connections are IEEE 802.11 and Personal Area Network (PAN) connections such as Bluetooth. Also, a Subscriber Station 204 may include the ability to connect via 802.16 links to one or more additional Subscriber Station 204 or Mobile Station 206, thus, effectively extending the range of the Wide Area Network 200. Additionally, Foreign Terminal Equipment 216 (Terminal Equipment that has never been connected to the Subscriber Station 204) may come in to contact with the Subscriber Station 204 and obtain access to the Customer Premises Network 210 or the Wide Area Network 200.

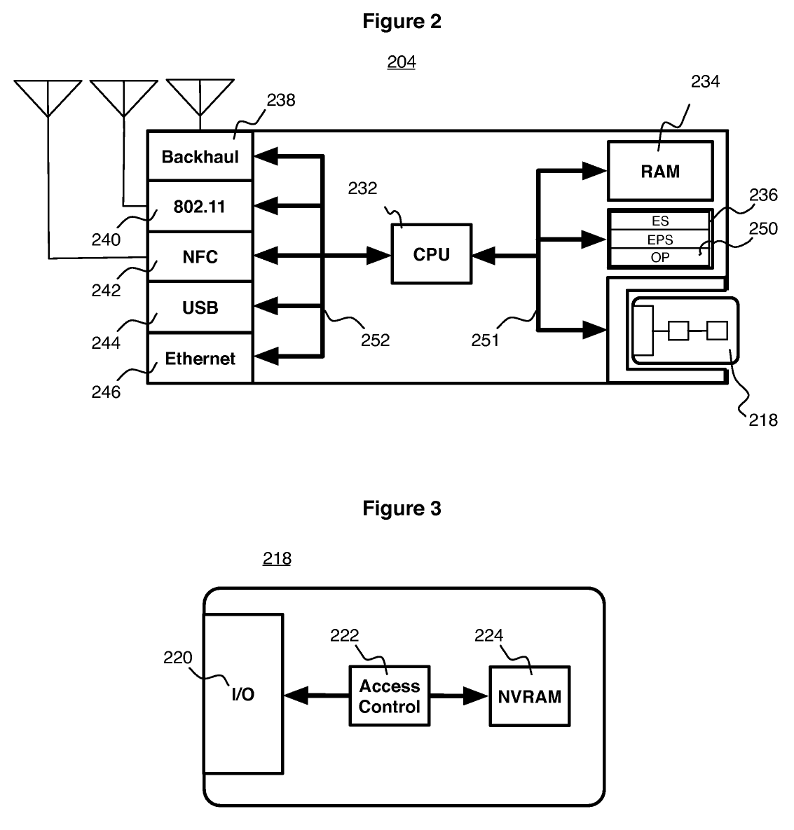

In one embodiment shown in FIG. 2, the Subscriber Station 204 includes a central processing unit 232 with a memory bus 251 and an input/output bus (I/O bus) 252. Residing on the I/O bus 252 are a wireless back-haul connection element 238 such as an 802.16 wireless connection element, and various other connection elements, e.g., an 802.11 wireless connection element 240, a Near Field Communications wireless connection element (NFC) 242 such as Bluetooth, a USB connection element 244, or an Ethernet connection element 246. Residing on the memory bus 251 are a Random Access Memory (RAM) 234, a Read Only Memory (ROM) 236, and a Secure Element (SE) 218.

Secure Element

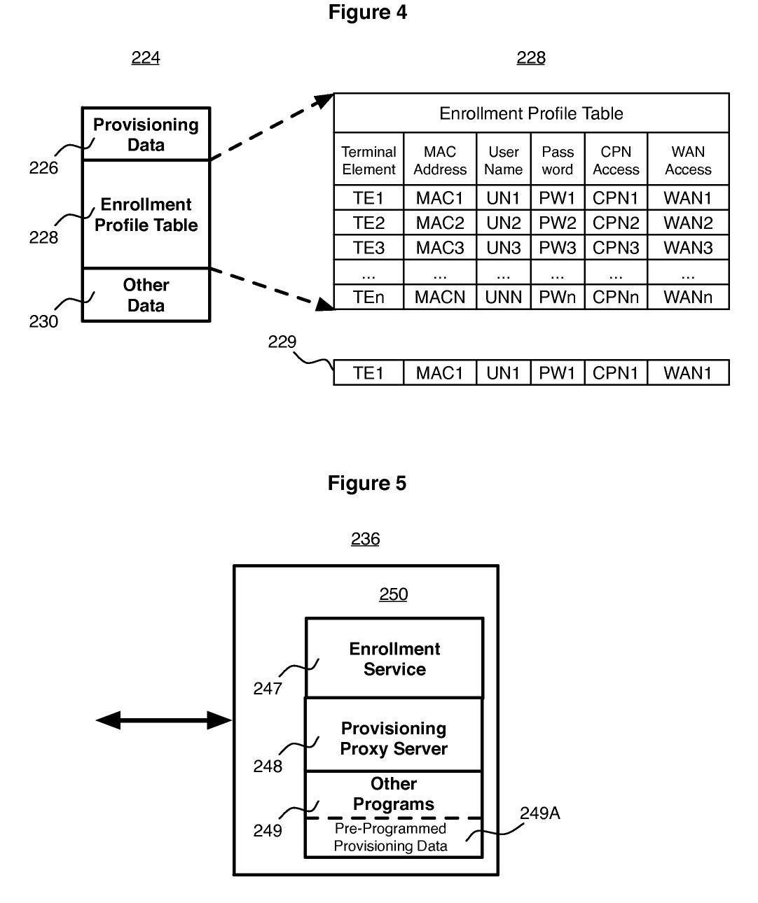

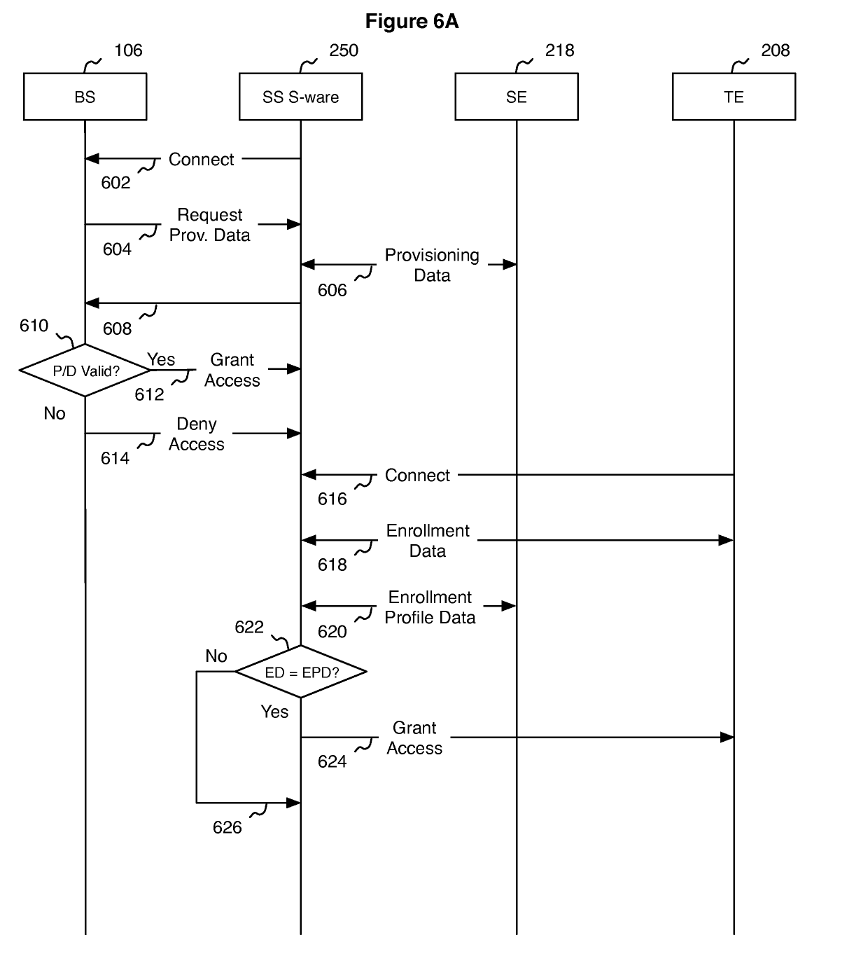

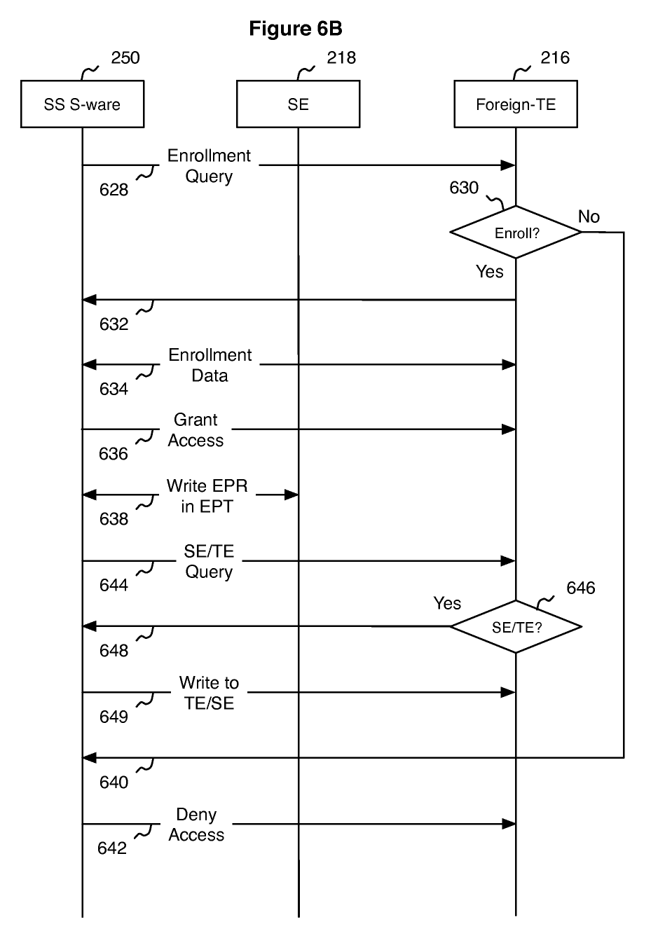

The Secure Element 218, shown in detail in FIG. 3, has input/output logic (I/O) 220, an access control element 222 and a non-volatile memory element 224. The I/O permits read/write access to the data stored in the non-volatile memory element 224. The access control element 222 provides a mechanism to maintain the security of the data stored in the non-volatile memory element 224 (e.g. processing means or encryption hardware). The data residing in the non-volatile memory element 224 is shown in FIG. 4, and includes provisioning data 226, an enrollment profile table 228 and possibly other data 230. When a Subscriber Station 204 first connects with the Base Station 106, a process of network entry and initialization occurs. In the IEEE 802.16 Broadband Wireless Access Standard for Local and Metropolitan Area Networks, the Subscriber Station 204 and the Base Station 106 take several steps to establishing a basic wireless connection (e.g., obtaining downlink and uplink synchronization, setting ranging parameters, and negotiating basic capabilities). These activities do not require any unique identifying information to be shared between the Subscriber Station 204 and the Base Station 106, but are dictated by hardware capabilities. Next, a series of authorization and registration steps are taken to uniquely identify the Subscriber Station 204, and share encryption keys. These steps require that unique information identifying the hardware be shared between the Subscriber Station 204 and the Base Station 106 (e.g. transmission of the Subscriber Station 204 MAC address). Finally, a series of provisioning steps are taken to identify the user of the Subscriber Station, the network and other account related parameters and determine quality-of-service levels. The provisioning data 226 residing in the non-volatile memory element 224 is accessed by the Subscriber Station 204 operating software when requested by the Network Access Provider 104 to administer account provisioning of the Subscriber Station 204 onto the Wide Area Network 200 as illustrated in FIG. 6, and described below. The Subscriber Station 204 software may be stored on a hard disk, Random-Access-Memory (RAM), Read-Only-Memory (ROM), firmware, a Programmable-Logic-Device, or other suitable memory storage medium.

The enrollment profile table 228 is made up of a unique enrollment profile record 229 for each Terminal Equipment device 208 that is permitted to access the resources in the Customer Premises Network 210. Each enrollment profile record 229 contains enrollment profile data sufficient to, at least, uniquely identify: the Terminal Equipment device 208, the user of the Terminal Equipment device, the user's permitted access level to the Customer Premises Network 210, and permitted access level to the Wide Area Network 200. Such enrollment profile data includes, but is not necessarily limited to, the Terminal Equipment device's 208 MAC address, the Terminal Equipment device user's user name and password for log-on authentication, fields for controlling access to other devices in the Customer Premises Network 210 and to the Wide Area Network 200, and any encryption keys associated with the Terminal Equipment device 208. As illustrated in greater detail in conjunction with the flow-chart of FIG. 6, and described below, the enrollment profile table is accessed by the subscriber station software 250 to determine if a Terminal Equipment device 208 that connects to the Subscriber Station 204 has an associated enrollment profile record 229, and if so, to administer the Terminal Equipment device's 208 access to the Customer Premises Network 210 and the Wide Area Network 200 as indicated in the enrollment profile data.

The Secure Element 218 is either embedded in the Subscriber Station, or removable; for example, the Secure Element 218 may be a removable smart card. Using a removable Secure Element 218 permits the Network Access Provider 104 to conveniently cooperate with Subscriber Station manufacturers or retailers to provide out-of-the-box access to the Wide Area Network 200 by supplying manufacturers and retailers with removable Secure Elements 218 pre-programmed with valid provisioning data. Additionally, the removable Secure Element 218 permits Subscriber Station owners to easily upgrade their networks, because all the provisioning data and the enrollment profile records accumulated in the enrollment profile table are portable to a new Subscriber Station 204 and the Customer Premises Networks 210 are reestablished as soon as the removable Secure Element 218 is installed into the new Subscriber Station 204.

Enrollment Service

The subscriber station software 250, shown in FIG. 5, is stored in the ROM 236, and includes an Enrollment Service (ES) 247, and Provisioning Proxy Server (PPS) 248 and other programs 249 necessary to the operation of the Subscriber Station 204. Note that, per the 802.16 specification, the other programs 249 may include a provisioning data field 249A that has been pre-programmed into the Subscriber Station 204 by the manufacturer. According to the present invention, the provisioning data 226 in the non-volatile memory element 224 in the Secure Element 218 may be the same as the provisioning data field 249A in the other programs 249 in the ROM 236, or the provisioning data 226 in the non-volatile memory element 224 in the Secure Element 218 may be different than the provisioning data field 249A in the other programs 249 in the ROM 236. When the provisioning data 226 in the non-volatile memory element 224 in the Secure Element 218 is different than the provisioning data field 249A in the other programs 249 in the ROM 236, only the provisioning data 226 in the non-volatile memory element 224 in the Secure Element 218 is used in the following descriptions.

As illustrated in the flow-chart of FIG. 6A, the Subscriber Station 204 first connects at 602 to the Base Station 106. When, in the course of network entry and initialization, the Base Station 106 requests provisioning data 226 at 604, the Subscriber Station 204 (through one of the other programs 249 in the subscriber station software 250) reads the provisioning data 226 at 606 from the Secure Element 218 and passes it to the Base Station 106 at 608. The Base Station 106 determines at 610 if the provisioning data 226 is valid and either grants the Subscriber Station 204 appropriate access to the Wide Area Network 200 at 612 or denies access at 614.

The Enrollment Service 247 administers the authentication of Terminal Equipment 208 permitted on the Customer Premises Network 210 (i.e., Terminal Equipment 208 with valid enrollment profile records in the enrollment profile table in the Secure Element 218). As further illustrated in the flow-chart of FIG. 6A, the Subscriber Station 204 (through the Enrollment Service 247 in the subscriber station software 250) detects at 616 when a Terminal Element 208 connects to the Subscriber Station 204 on, for example, the 802.11 wireless connection element 240, the Near Field Communications wireless connection element 242, the USB connection element 244, or the Ethernet connection element 246. The Enrollment Service 247 then requests at 618 the enrollment data from the Terminal Element 208. The Enrollment Service 247 accesses at 620 the enrollment profile table 228 in the non-volatile memory element 224 in the Secure Element 218, and determines at 622 if there is a corresponding enrollment profile record 229 for the connected Terminal Element 208. If there is a corresponding enrollment profile record 229, the connected Terminal Element 208 is granted access at 624 to the Wide Area Network 200 or the Customer Premises Network 210 as dictated by the access fields specified in the enrollment profile record 229. If there is no corresponding enrollment profile record 229, either because the connected Terminal Element 208 is new and has never connected to any Customer Premises Network 210, or because it is a Foreign Terminal Element 216, as described below, the Enrollment Service 247 initiates an enrollment process for the connected Terminal Element 208 as described below.

Because of the mobility of Terminal Equipment 208 or 216, it is possible for any given Terminal Element 208 or 216 to be physically moved into range of a Subscriber Station 204 to which it has no previous affiliation and therefore has no enrollment record 229 in the enrollment profile table 228 of that Subscriber Station 204. Such a Terminal Element is referred to as a Foreign Terminal Element 216. As illustrated in the flow-chart of FIGS. 6A and B, the Enrollment Service 247 in the subscriber station software 250 will determine at 622 that a Foreign Terminal Element 216 has connected to the Subscriber Station 204. In this case the Enrollment Service 247 initiates an enrollment process at 628 with the Foreign Terminal Element 216 through, for example, a web interface. Through the web interface, the owner of the Foreign Terminal Element 216 may choose at 630 to enroll on the Customer Premises Network 210 created by the given Subscriber Station 204, gain access to the Wide Area Network 200 or have no access at all, according to various enrollment term options (e.g., hourly/daily/monthly rates, long term contracts, guest accounts). If any access option is selected at 632, the Enrollment Service 247 obtains all applicable enrollment data at 634 (e.g., identity and billing information) and grants the Foreign Terminal Element 216 the appropriate access to the Customer Premises Network 210 or Wide Area Network 200 at 636. The Enrollment Service 247 then writes at 638 the associated enrollment profile record 229 in the enrollment profile table 228 in the Secure Element 218. If no access options are chosen by the Foreign Terminal Element 216 user at 640, then the Enrollment Service 247 denies at 636 the Foreign Terminal Element 216 any access to the Customer Premises Network 210 or Wide Area Network 200.

Note that the above description assumes that the Foreign Terminal Element 216 has a user interface in order to select the various enrollment term options. However, this is not a limitation under the current invention. When the Foreign Terminal Element 216 has no user interface (e.g. an MP3 player or digital camera), the Enrollment Service 247 initiates an enrollment process at 628 with the Foreign Terminal Element 216, but here, the subscriber station software 250 provides the user interface through which the owner of the Foreign Terminal Element 216 may choose at 630 from the various enrollment term options. This embodiment envisions situations that include an individual who owns a Subscriber Station 204, and who then purchases a Foreign Terminal Equipment 216 device with no user interface (e.g. a digital camera). In this case, the owner can use the Subscriber Station 204 to provide the user interface to convert the Foreign Terminal Equipment 216 device to a known Terminal Equipment 208 device so that the device can access the Customer Premises Network 210 (e.g., to permit the camera to upload pictures). This embodiment further envisions situations where a merchant owns a Subscriber Station 204, and provides a user interface to their customers so that the customers can enroll Foreign Terminal Equipment 216 devices with no user interface onto the merchant's Customer Premises Network 210,

Provisioning Proxy Server

A typical Subscriber Station 204 includes other programs 249 in the subscriber station software 250 that detect when a Mobile Station (MS) 206 comes within range of the wireless back-haul connection element 238 of the Subscriber Station 204. In this case, the Subscriber Station 204 acts as a Base Station 106 to administer the authorization and registration activities of the Mobile Station 206 onto the Wide Area Network 200 and as a repeater, femto-cell, pico-cell, etc, extending the geographic reach of the Wide Area Network 200. The Subscriber Station 204 establishes the basic wireless connection with the Mobile Station 206, and initiates the series of registration steps necessary to identify the Mobile Station 206 and share encryption keys. Finally, the Subscriber Station 204 provisions the Mobile Station 204 according to provisioning data supplied by the Mobile Station 206. Note that the Subscriber Station 204 operator must maintain its own account management system to track the credentials of all Mobile Stations 206 with valid accounts on the Subscriber Station 204. Also, Mobile Station 206 owners must establish separate accounts with each Subscriber Station 204 with which they desire access.

However, the subscriber station software 250 of the present invention includes a Provisioning Proxy Server 248. Here, the Subscriber Station 204 establishes the wireless connection with the Mobile Station 206, initiates registration and shares encryption keys. However, when it comes to the provisioning steps, the Provisioning Proxy Server 248 acquires the provisioning data from the Mobile Station 206, and grants the Mobile Station 206 a basic level of provisioned access to the Wide Area Network 200. The Provisioning Proxy Server 248 then serves the provisioning data from the Mobile Station 206 up to the Base Station 106 to determine the appropriate quality of service and account usage levels. The Provisioning Proxy Server 248 then grants the quality of service and account usage levels to the Mobile Station 206.

Security Enabled Terminal Element

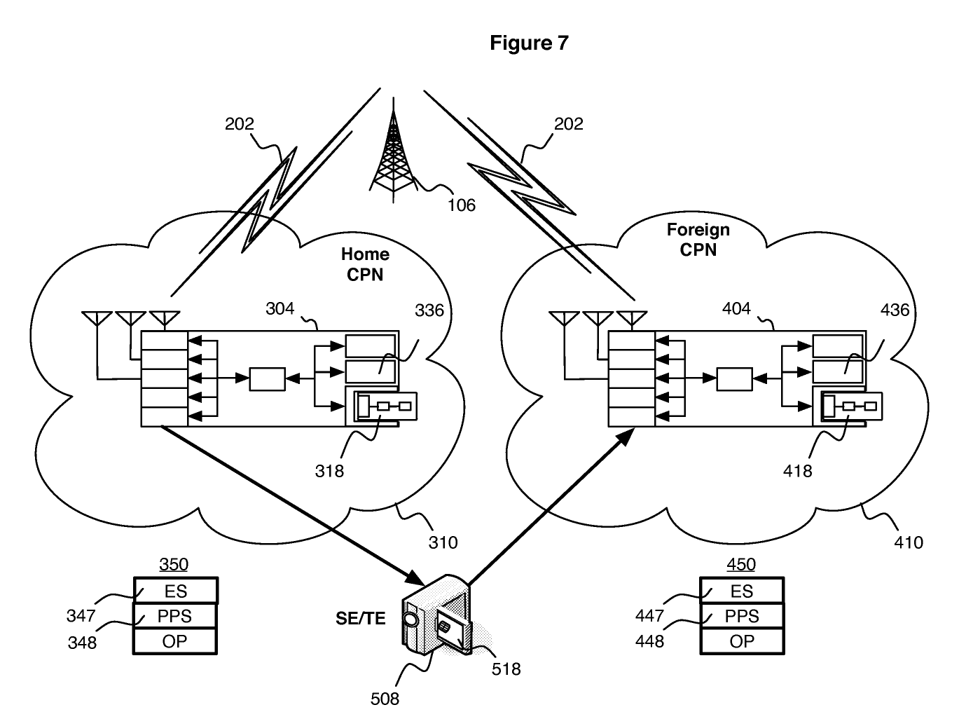

A similar scenario is illustrated in FIG. 7 where two subscriber stations, a Home Subscriber Station 304 and a Foreign Subscriber Station 404, are both connected to the Base Station 106. Each subscriber station 304 and 404 hosts an associated Customer Premises Network, the Home CPN 310 and the Foreign CPN 410. The ROM 336 in the Home Subscriber Station 304 includes home subscriber station software 350 that includes a Home Provisioning Proxy Server 348. Similarly, the ROM 436 in the Foreign Subscriber Station 404 includes foreign subscriber station software 450 that includes a Foreign Provisioning Proxy Server 448. The Home Subscriber Station 304 includes a Home Secure Element 318 and the Foreign Subscriber Station 404 includes a Foreign Secure Element 418. Each Secure Element 318 and 418 has associated non-volatile memory elements (not shown) that store the associated subscriber station's (home) 304 and (foreign) 404 provisioning data and enrollment profile tables.

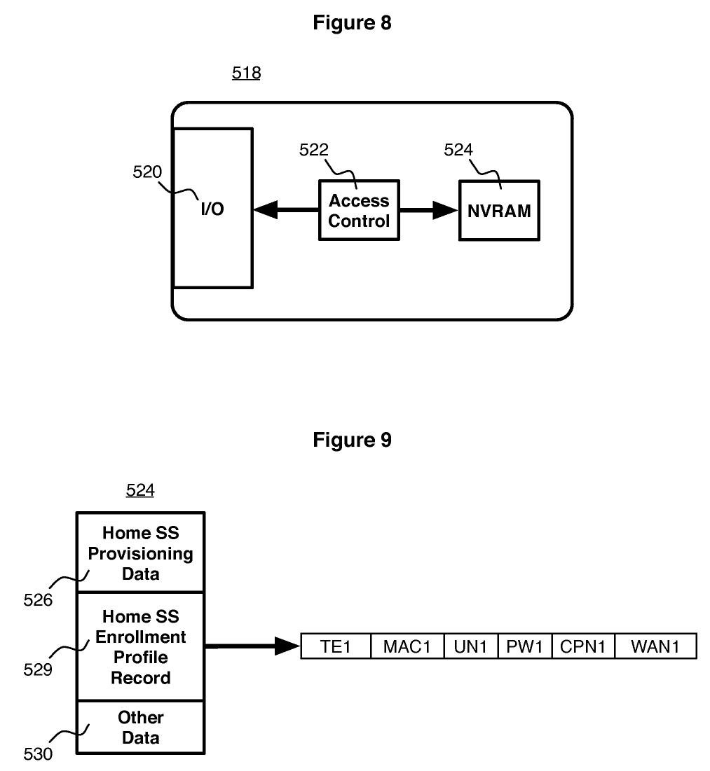

A Security Enabled Terminal Element 508 is part of the Home CPN 310 (i.e., the Security Enabled Terminal Element 508 has an associated enrollment profile record in the enrollment profile table stored on the Home Secure Element 318). The Security Enabled Terminal Element 508 contains a TE Secure Element 518. The TE Secure Element 518, as shown in FIG. 8, is similar to the Secure Element 218 described above, in that the TE Secure Element 518 has input/output logic (I/O) 520, an access control element 522 and a non-volatile memory element 524. However, the data stored on the non-volatile memory element 524, as shown in FIG. 9, includes the Home Subscriber Station provisioning data 526 (i.e., a copy of the provisioning data stored on the Home Secure Element 318), the Home Subscriber Station enrollment profile record 529 (i.e., a copy of the Security Enabled Terminal Element's 508 associated enrollment profile record from the enrollment profile table stored on the Home Secure Element 318) and other data 530. In this case, the Home Enrollment Service 346 writes the Home Subscriber Station provisioning data 526 and the Home Subscriber Station enrollment profile record 529 into the non-volatile memory element 524 in the TE Secure Element 518 as a part of the initial enrollment process, as illustrated in FIG. 6B. Here, after enrolling a new Foreign Terminal Element 216 in the process ending at 638, the Enrollment Service 247 in the Subscriber Station operating software 450 queries at 644 the Foreign Terminal Element 216 if it is a Security Enabled Terminal Element 518. The Foreign Terminal Element 216 responds at 646. If the Foreign Terminal Element 216 either responds negatively, or does not respond at all, no further processing is performed. If the Foreign Terminal Element 216 either responds that it is also a Security Enabled Terminal Element 518, at 648, then the Provisioning Proxy Server 248 in the Subscriber Station operating software 250 writes at 649 the Home Subscriber Station provisioning data 526 and the Home Subscriber Station enrollment profile record 529 into the non-volatile memory element 524 in the TE Secure Element 518.

The Foreign Provisioning Proxy Server 448 permits a Security Enabled Terminal Element 508 to bypass the new enrollment function of the Foreign Enrollment Service (not shown) and connect directly to the Wide Area Network 200 under the Home Subscriber Station provisioning data 526 and the Home Subscriber Station enrollment profile record 529. In this way, a user of a Security Enabled Terminal Element 508 gains greater mobility and seamless access to the Wide Area Network 200.

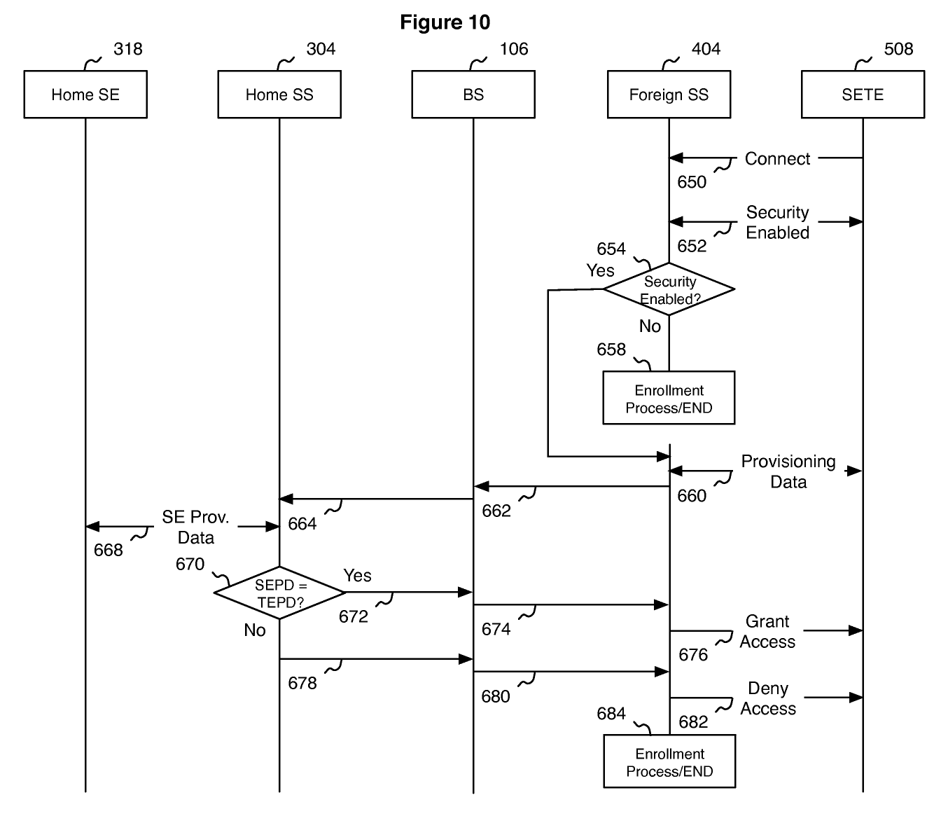

In this scenario, the Foreign Provisioning Proxy Server 448 in the Foreign Subscriber Station 404 validates the provisioning data and enrollment profile data of a Security Enabled Terminal Element 234 from a Home Customer Premises Network 260 when the Security Enabled Terminal Element 234 is taken from the area served by the Home Subscriber Station 262 and moved into the area served by the Foreign Subscriber Station 272. As illustrated in the flow-chart of FIG. 10, when a Terminal Element 208 or a Security Enabled Terminal Element 508 connects at 650 to a Foreign Subscriber Station 404, the Foreign Provisioning Proxy Server 248 queries at 652 whether the Terminal Element 208 or 508 has a TE Secure Element 518. The Foreign Provisioning Proxy Server determines at 654 whether the connected Terminal Element is Security Enabled. If the connected Terminal Element 208 is not Security Enabled, further processing is handed at 658 to the Enrollment Service 446 for enrollment processing as described above and illustrated in FIG. 6A, starting at 616. If the connected Terminal Element 508 is Security Enabled, the Foreign Provisioning Proxy Server 448 requests at 660 the Home Subscriber Station provisioning data 526 and the Home Subscriber Station enrollment profile record 529 (hereinafter referred to collectively as “the SETE data”) from the TE Secure Element 518 and serves the SETE data at 662 to the Base Station 106, which in turn serves the SETE data at 664 to the Home Subscriber Station 304. The Home Subscriber Station's 304 Home Provisioning Proxy Server 348 reads at 668 the provisioning data and the Security Enabled Terminal Element's 508 enrollment profile record from the Home Secure Element 318. The Home Provisioning Proxy Server 348 checks at 670 the veracity of the SETE data against the provisioning data and enrollment profile record in the Home Secure Element 318. If the SETE data matches, the Home Provisioning Proxy Server 348 returns the result of “verified” at 672 to the Base Station 106, which serves the result at 674 to the Foreign Subscriber Station 404. Finally, the Foreign Provisioning Proxy Server 248 grants at 676 the Security Enabled Terminal Element 508 access to the Wide Area Network 200 in accordance with the SETE data. If the SETE data does not match, the Home Provisioning Proxy Server 348 returns the result of “not verified” at 678 to the Base Station 106, which serves the result at 680 to the Foreign Subscriber Station 404. Finally, the Foreign Provisioning Proxy Server 248 denies at 682 the Security Enabled Terminal Element 508 access to the Wide Area Network 200 and further processing is handled at 684 to the Enrollment Service 446 for enrollment processing as described above and illustrated in FIG. 6A, starting at 616.

In another embodiment, not shown, the Foreign Provisioning Proxy Server 448 requests the Home Subscriber Station provisioning data 526 and the Home Subscriber Station enrollment profile record 529 from the TE Secure Element 518 and grants access to the Wide Area Network 200 in accordance with the requested data (i.e., under the credentials of the Security Enabled Terminal Element's 508 Home Subscriber Station) and then verifies the SETE data as described above. This permits the Security Enabled Terminal Element 508 user to have instant access to the Wide Area Network 200 without having to wait for the verification process.

In another embodiment, not shown, all of the provisioning data and enrollment profile tables from the Home Secure Element 318 and the Foreign Secure Element 418 are synchronized into a database maintained by the Base Station 106. When a Security Enabled Terminal Element 508 connects to a Foreign Subscriber Station 404, the Foreign Provisioning Proxy Server 448 requests the Home Subscriber Station provisioning data 526 and the Home Subscriber Station enrollment profile record 529 from the TE Secure Element 518 and serves the SETE data to the Base Station 106. The Base Station 106 checks the veracity of the Terminal Element data against the database and returns a result (verified/not verified) to the Foreign Subscriber Station 404. If the SETE data is verified, the Foreign Enrollment Proxy Server 448 grants the Security Enabled Terminal Element 508 access to the Wide Area Network 200. If the SETE data is not verified, the Foreign Enrollment Proxy Server 448 denies the Security Enabled Terminal Element 508 access to the Wide Area Network 200.

Enhanced Secure Element

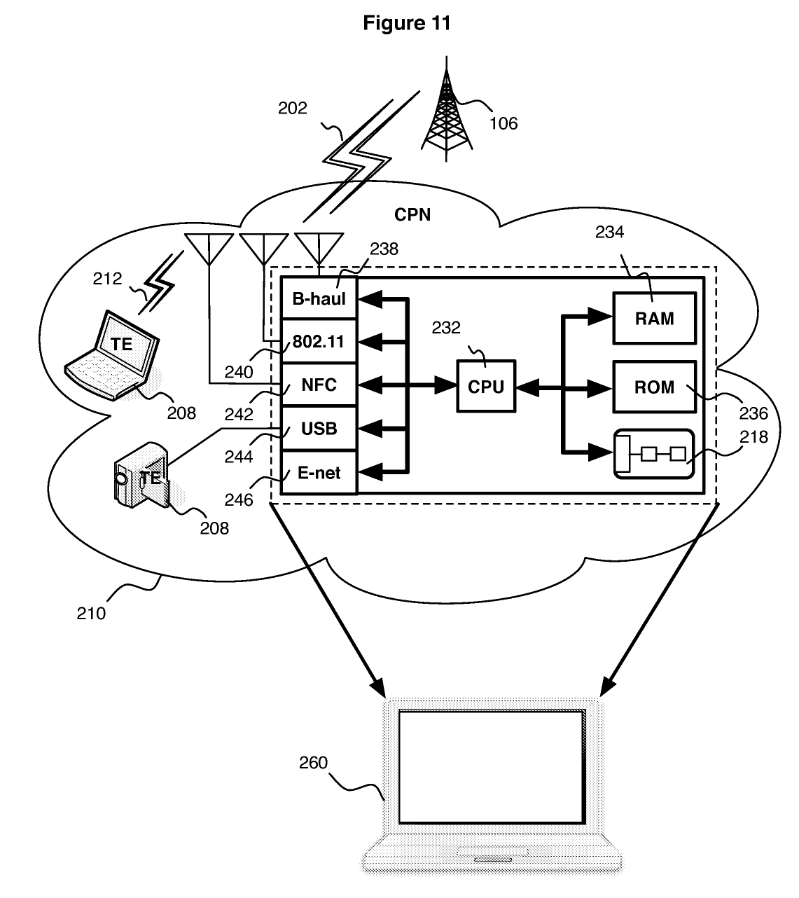

Another embodiment of the present invention is illustrated in FIG. 11, wherein a Secure Element 218 is included in a mobile device 260, e.g., a Laptop Computer. In this case, the Laptop Computer 260 includes a wireless back-haul connection element 238, which is used to establish a communications channel between the Laptop Computer 260 and the Base Station 106. In addition, the Laptop Computer 260 has other connection elements (e.g., an 802.11 wireless connection element 240, a Near Field Communications (e.g., Bluetooth) wireless connection element 242, a USB connection element 244, or an Ethernet connection element 246) to establish connections between the Laptop Computer 260 and the various Terminal Equipment 208. Additionally, the Laptop Computer 260 has a Random Access Memory (RAM) 234, and a Read Only Memory (ROM) 236. The Read Only Memory 236 stores, among other programs, an Enrollment Service 247 and a Provisioning Proxy Server 232 as described above. Thus, a Laptop Computer 260 has the capability to establish a Customer Premises Network 210 (e.g., including itself and the various terminal equipment 208) and to act as a repeater, extending the geographic reach of the Wide Area Network 200. The Secure Element 218 is either embedded in the Laptop Computer 260 or it is removable. A removable Secure Element 218 confers similar functionality in terms of convenient out-of-the-box access to the Wide Area Network 200 and simple upgrade path as described above.

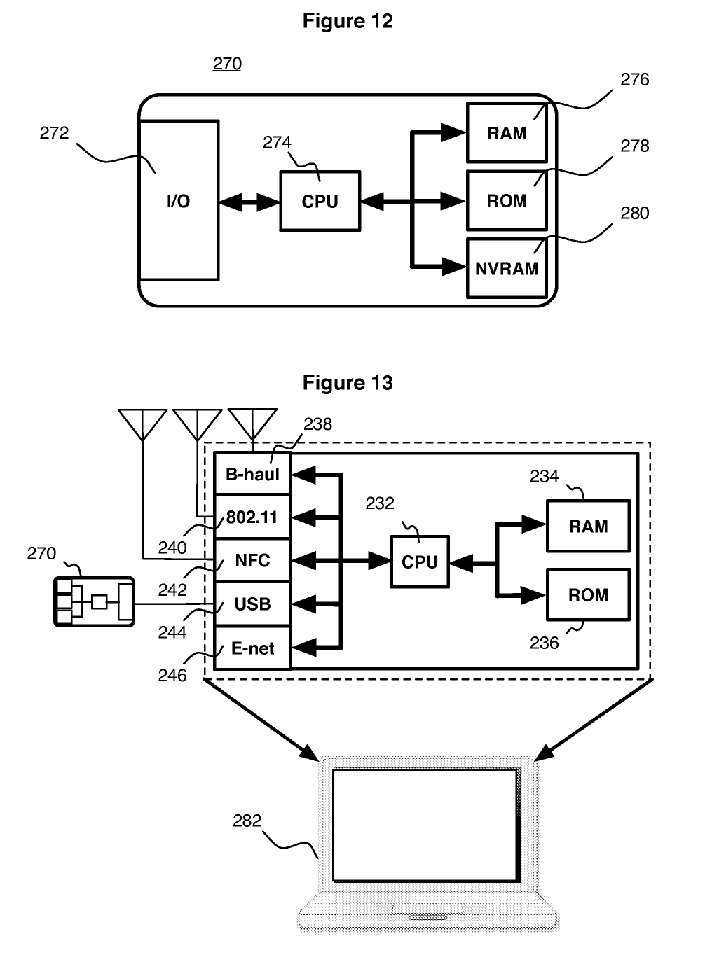

Another embodiment is shown in FIG. 12, where an Enhanced Secure Element (ESE) 270 includes input/output logic (I/O) 272, a Central Processing Unit (CPU) 274, a Random Access Memory (RAM) 276, a Read Only Memory (ROM) 278, and a non-volatile memory element (NVRAM) 280. Here, the Read Only Memory 278 includes an Enrollment Service 247, a Provisioning Proxy Server 248 and other programs 249 necessary to implement the functionality of a Subscriber Station 204, as described above. The non-volatile memory element 280 stores provisioning data 226, and enrollment profile table 228 as described above. The Enhanced Secure Element 270 can be embedded or removable. In either case, the Enhanced Secure Element brings all the functionality of a Subscriber station into one compact device (e.g., a smart card, a single chip solution, or as embedded logic on a larger integrated circuit). FIG. 13 shows the present embodiment packaged as a USB device. Here, the Enhanced Secure Element 270 is plugged in to a laptop computer 282 as described above, with the exception that this laptop computer 282 lacks the embedded Secure Element 218. When plugged in to the laptop computer 282, the USB management software installs the contents of the non-volatile memory element 280 to the Random Access Memory 234 in the laptop computer 282. In this way, the Enhanced Secure Element can turn any device with a wireless backhaul element 238 into a fully functioning Subscriber Station 204.

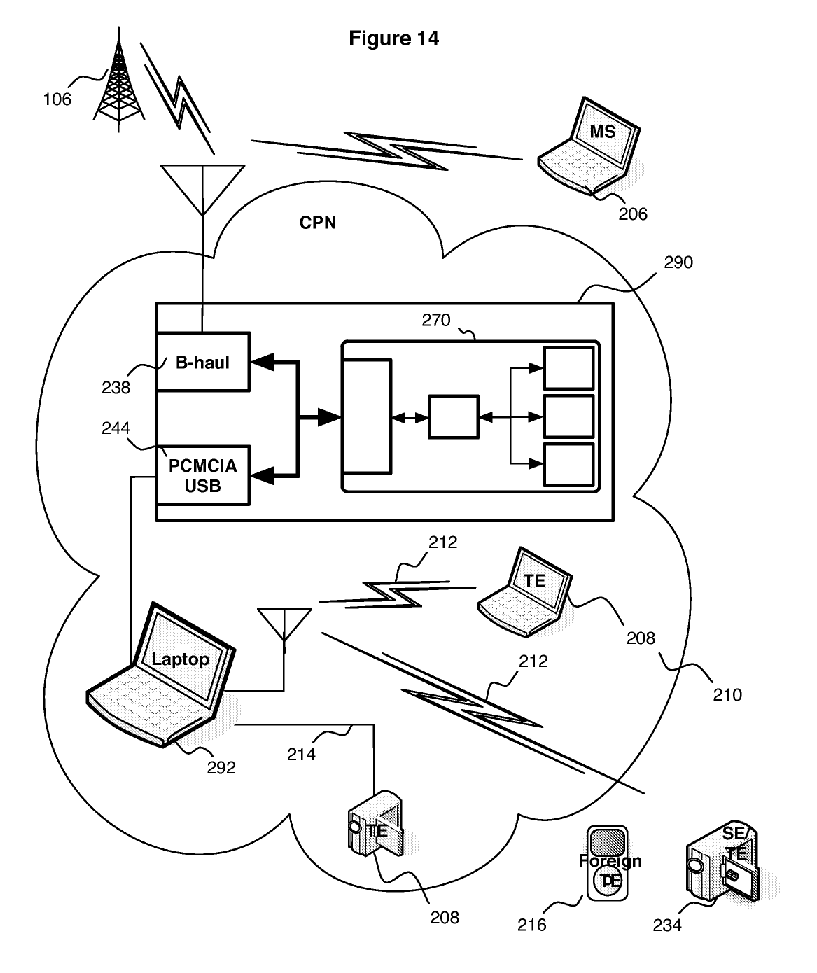

FIG. 14 shows another embodiment of the present invention wherein the complete functionality of a Subscriber Station 204 is implemented on a dongle that connects to, for example the USB or PCMCIA port of a laptop computer. In this embodiment, the Subscriber Station Dongle 290 includes an Enhanced Secure Element 270, a wireless back-haul connection element 238, and one connection element 244 that connects to, for example, a laptop computer 292 that does not have its own wireless back-haul connection element. Further, while the Subscriber Station described above is a stand-alone device with its own power supply, the Subscriber Station Dongle 290 derives its power from the laptop computer 292.

Work Flow

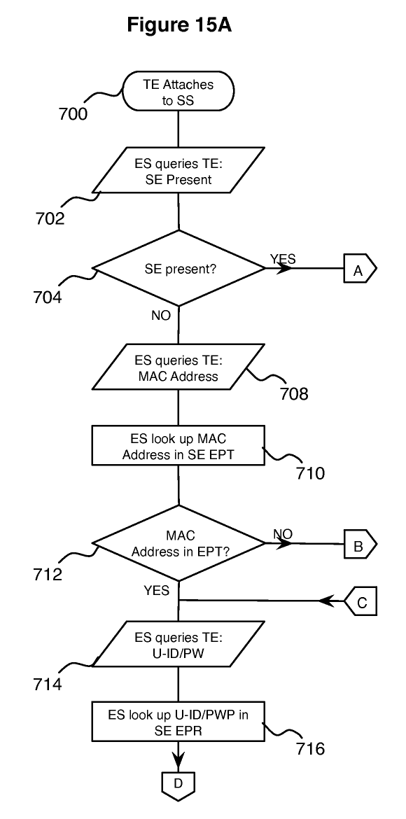

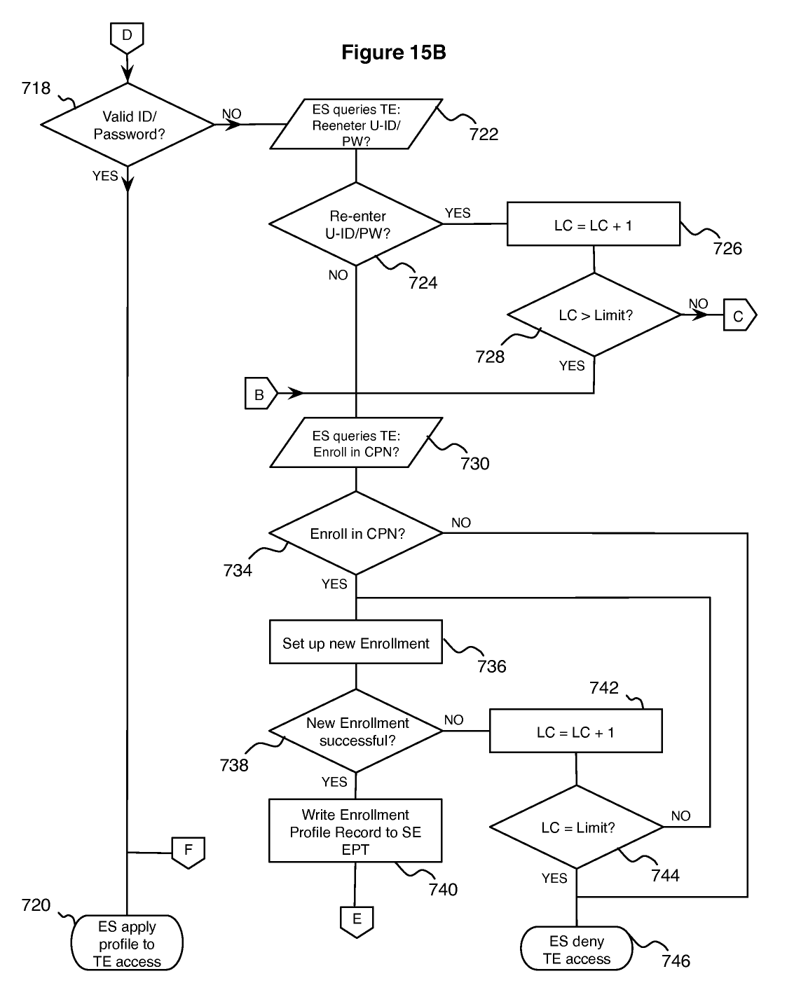

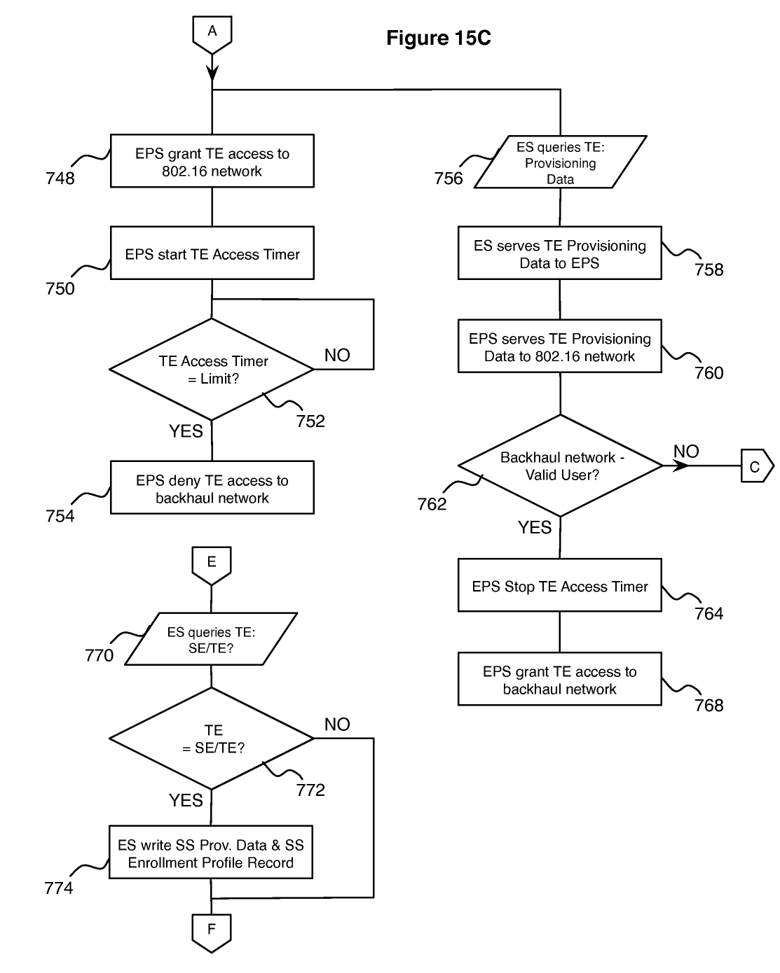

FIG. 15A-C is a flowchart illustrating the process flow of one example of using a Secure Element 218 in a Subscriber Station 204. When any Terminal Element 208, 216 or 508 connects to a connection element 238, 240, 242, 244, or 246 of the Subscriber Station 204, Step 500, the Enrollment Service executing on the Subscriber Station first queries the Terminal Element 208, 216 or 508 as to whether a Secure Element 518 is present (i.e., to determine whether the Terminal Element 208, 216 or 508 is a Security Enabled Terminal Element 508), Step 510. If the Terminal Element 208, 216 or 508 reports back that it is a Security Enabled Terminal Element 508, Decision 520, processing proceeds at A, FIG. 8C, which is described below. If the Terminal Element is not a Security Enabled Terminal Element 508, Decision 520, then the Enrollment Service 247 queries for the Terminal Element 208 or 216 MAC address, Step 540. The Enrollment Service 247 then searches the enrollment profile table 228 in the Secure Element 218 for the Terminal Element 208 or 216 MAC address, Step 550, and determines if the Terminal Element 208 or 216 MAC address is present in the enrollment profile table 228, Decision 560, (i.e. whether the Terminal Element 208 or 216 MAC address corresponds with any of the enrollment profile records 229 in the enrollment profile table 228). If the Terminal Element 208 or 216 MAC address is not present in the enrollment profile table 228, Decision 560, then the terminal element is a Foreign Terminal Element 216, and the Enrollment Service 247 proceeds to set up a new enrollment for the Foreign Terminal Element 216 at B, FIG. 8B, as discussed below. If the Terminal Element 208 or 216 MAC address is present in the enrollment profile table 228, Decision 560, then the Enrollment Service queries the Terminal Element 208 for User ID and Password, Step 580. The Enrollment Service then reads the User ID and Password in the enrollment profile record 229 in the Secure Element 218, Step 590, and the process flow proceeds at D, FIG. 8B. The Enrollment Service 247 compares the User ID and Password provided by the Terminal Element 208 user with the User ID and Password contained in the corresponding enrollment profile record 229 in the Secure Element 218, Decision 600. If the User ID and Password provided by the Terminal Element 208 user matches the User ID and Password contained in the corresponding enrollment profile record 229 in the Secure Element 218, Decision 600, then the Enrollment Service 247 permits the Terminal Element 208 access to the Wide Area Network 200 or Customer Premises Network 210 as required by the control fields in the corresponding enrollment profile record 229, Step 610.

If the User ID and Password provided by the Terminal Element 208 user does not match the User ID and Password contained in the corresponding enrollment profile record 229 in the Secure Element 218, Decision 600, then the Enrollment Service 247 queries whether the Terminal Element 208 user wants to re-enter the User ID and Password, Step 620. If the Terminal Element 208 user chooses to re-enter the User ID and Password, Decision 630, a Loop Counter is incremented, Step 640, and the Loop Count is checked against a Loop Count Limit, Decision 650. If the Loop Count is less than the Loop Count Limit, Decision 650, the process returns at C, FIG. 8C, to Step 580 (Enrollment Service 247 queries the Terminal Element 208 for User ID and Password).

If either the Enrollment Service 247 determines that the Terminal Element 216 or 508 MAC address is not valid, Decision 560, at D, from FIG. 8A, or the Terminal Element 208 user chooses not to re-enter the User ID and Password, Decision 630, or the Loop Count is greater than the Loop Count Limit, Decision 650, the Enrollment Service 247 queries whether the Terminal Element 208, 216 or 508 user wants to enroll on the Customer Premises Network 210, Step 670. If the Terminal Element 208, 216 or 508 user does not want to enroll on the Customer Premises Network 210, Decision 680, the Enrollment Service 247 denies the Terminal Element 208, 216 or 508 access to the Customer Premises Network 210 or to the Wide Area Network 200, Step 740. If the Terminal Element 208, 216 or 508 user desires to enroll on the Customer Premises Network 210, Decision 680, the Enrollment Service 247 engages the Terminal Element 208, 216 or 508 user to establish the enrollment, Step 690. This step involves, e.g., determining access profiles, obtaining billing and credit card information, etc., that are beyond the scope of the present invention. If the enrollment on the Customer Premises Network 210 is successful, Decision 700, the Enrollment Service 247 writes a new enrollment profile record 229 for the Terminal Element 208, 216 or 508 into the enrollment profile table 228 in the Secure Element 218, Step 710 and processing continues at E, FIG. 15C, where the Enrollment Service 247 queries the Terminal Element 208, 216 or 508 at 712 as to whether a Secure Element 518 is present. If the Terminal Element 208, 216 or 508 reports back that it is a Security Enabled Terminal Element 508, Decision 712, then the Enrollment Service 247 writes at 716 the Subscriber Station provisioning data 226 and the Subscriber Station enrollment profile record 229 non-volatile memory element 424 in the TE Secure Element 518 and processing continues at F. If the Terminal Element 208, 216 or 508 is not a Security Enabled Terminal Element 508, Decision 714, then processing continues at F, where the Enrollment Service 247 permits the Terminal Element 208, 216 or 508 access to the Wide Area Network 200 or Customer Premises Network 210 as required by the control fields in the enrollment profile record 229, Step 610. If the enrollment on the Customer Premises Network 210 is unsuccessful, Decision 700, a Loop Counter is incremented, Step 720, and the Loop Count is checked against a Loop Count Limit, Decision 730. If the Loop Count is less than the Loop Count Limit, Decision 730, the process returns to 690 (the Enrollment Service 247 engages the Terminal Element 208, 216 or 508 user to establish the enrollment). If the Loop Count is greater than the Loop Count Limit, Decision 730, the Enrollment Service 247 denies the Terminal Element 208, 216 or 508 access to the Customer Premises Network 210 or to the Wide Area Network 200, Step 740.

If, upon connection of a Terminal Element 208, 216 or 508 to a connection element 238, 240, 242, 244, or 246 of the Subscriber Station 204, the Enrollment Service 247 discovers a Security Enabled Terminal Element 508, Decision 520, FIG. 8A, then processing proceeds at A, FIG. 8C, along two parallel lines. First, the Enrollment Service 247 grants the Terminal Element 508 access to the Wide Area Network 200 using the provisioning data found in the Security Enabled Terminal Element 508 Secure Element 518, Step 750. The Enrollment Service 247 next starts a Terminal Element Access Timer, Step 760, and enters a time delay loop until the Terminal Element Access Timer reaches a predetermined limit, Decision 770. When the Terminal Element Access Timer limit is reached, Decision 770, the Enrollment Service 247 revokes the access to the Wide Area Network 200 granted to the Security Enabled Terminal Element 508, Step 780. While the timer function is proceeding, the Enrollment Service 247 queries the Security Enabled Terminal Element 508 for the Home Subscriber Station provisioning data 526 and the Home Subscriber Station enrollment profile record 529 (SETE data), Step 790. The Enrollment Service 247 serves the SETE data to the Provisioning Proxy Server 248, Step 800, which in turn provides the SETE data to the Base Station 106, Step 810, and the Base Station 106 validates the SETE data, Decision 820. If the SETE data is valid, Decision 820, the Provisioning Proxy Server 248 stops the Terminal Element Access Timer, Step 830, and the Provisioning Proxy Server 248 grants the Security Enabled Terminal Element 508 access to the Wide Area Network 200, Step 840. If the SETE data is not valid, Decision 820, processing proceeds at C, FIG. 8A, to 570 (the Enrollment Service 247 queries whether the Terminal Element 508 user wants to enroll on the Customer Premises Network 210).

From the foregoing it will be apparent that the secure subscriber station and the associated security enabled terminal element of the present invention provide secure and mobile access to a Wide Area Network.

Although specific embodiments of the invention have been described and illustrated, the invention is not to be limited to the specific forms or arrangements of parts so described and illustrated. The invention is limited only by the claims.

What is claimed is the following:

1. A wireless network device for connecting one or more first terminal devices residing on a local area network to a wide area network, comprising:
a processor;
a secure element comprising a first memory element having storage therein for:
a first provisioning data field; and
an enrollment profile table comprising one enrollment profile record for every first terminal device residing on the local area network; and
storage having operating logic executable by the processing means and having instructions to cause the processor to:
retrieve the first provisioning data field to administer a first provisioning of the wireless network device onto the wide area network; and
retrieve the enrollment profile record of each first terminal device when said first terminal devices connect to the local area network to administer an authentication of each first terminal device onto the local area network and the wide area network based upon the contents of the enrollment profile record associated with each first terminal device in the enrollment profile table.

2. The wireless network device of claim 1 wherein the secure element is removable.

3. The wireless network device of claim 1 wherein the operating logic further includes instructions to cause the processor to:
identify any of one or more second terminal devices, none of which have an associated enrollment profile record in the enrollment profile table;
administer or deny an authentication of the second terminal devices onto the local area network based upon predetermined selection criteria and input decisions from the users of any of the one or more second terminal devices; and
add an enrollment profile record to the enrollment profile table for each second terminal device for which the enrollment service administers an authentication.

4. The wireless network device of claim 3 wherein the operating logic further includes instructions to cause the processor to:
determine whether any of the one or more second terminal devices has a second memory element containing a second provisioning data field;
retrieve the second provisioning data from the one or more second terminal devices; and
administer the second provisioning of the one or more second terminal devices onto the wide area network.

5. The wireless network device of claim 4 wherein the operating logic further includes instructions to cause the processor to write the first provisioning data field from the first memory element to the second memory element in the one or more second terminal devices.

6. The wireless network device of claim 4 wherein the operating logic further includes instructions to cause the processor to verify the validity of the second provisioning data field of the second terminal device.

7. The wireless network device of claim 6 wherein the wireless network device is embedded within a third terminal device.

8. The wireless network device of claim 6 wherein the wireless network device is a dongle.

9. A terminal device for connecting to a first wireless network device, comprising:
a memory element containing a subscription profile comprising authentication data, registration data and provisioning data from a second wireless network device, wherein the subscription profile is retrieved from the terminal device by operating software stored on the first wireless network device and having logic to administer the authentication, registration and provisioning of the terminal device onto a wide area network when executed by the first wireless network device.

10. A secure element in a wireless network device for connecting one or more first terminal devices residing on a local area network to a wide area network, comprising:
a processor;
an input/output controller connected to the processor;
a first memory element having stored therein
an administration logic executable by the processor to cause the processor to:
administer a first provisioning of the wireless network device onto a wide area network by retrieving a provisioning profile stored on the first memory element; and
administer an authentication of the one or more first terminal devices onto a local area network by retrieving an enrollment profile record associated with each first terminal device from an enrollment profile table stored on the first memory element.

11. The secure element of claim 10 the administration logic is further executable by the processor to cause the processor to:
identify any of one or more second terminal devices, none of which have an associated enrollment profile record in the enrollment profile table;
administer or deny an authentication of the second terminal devices onto the local area network and the wide area network based upon predetermined selection criteria and input decisions from the users of any of the one or more second terminal devices; and
add an enrollment profile record to the enrollment profile table for each second terminal device for which the enrollment service administers an authentication.

12. The secure element of claim 11 the administration logic is further executable by the processor to cause the processor to:
determine whether any of the one or more second terminal devices has a second memory element containing a second provisioning data field;
retrieve the second provisioning data from the one or more second terminal elements;
administer the second provisioning of the one or more second terminal devices onto the wide area network; and
write the first provisioning data field from the first memory element to the second memory element in the one or more second terminal devices.

13. The secure element of claim 12 the administration logic is further executable by the processor to cause the processor to verify the validity of the second provisioning data field of the second terminal device.

14. The secure element of claim 10 wherein the secure element is removable.

15. The secure element of claim 10 wherein the administration logic is selected from the group consisting of Random-Access-Memory, firmware, Read-Only-Memory, or a Programmable-Logic-Device.

16. A method of using a secure element in a wireless network device, said secure element having:
a processor;
an input/output controller connected to the processor, and
a memory element; and where
said method comprises:
creating a first provisioning profile data field in the memory element;
creating an enrollment profile table comprising one enrollment profile record for every first terminal device residing on a local area network associated with the wireless network device in the first memory element;
administering a first provisioning of the wireless network device onto a wide area network by retrieving the first provisioning profile data from the memory element; and
administering an authentication of the one or more said first terminal devices onto the local area network by retrieving the enrollment profile record associated with each first terminal device from the enrollment profile table stored on the memory element.

17. The method of using a secure element in a wireless network device of claim 16 wherein the method further comprises:
identifying any of one or more second terminal devices, none of which have an associated enrollment profile record in the enrollment profile table;
administering or deny an authentication of the second terminal devices onto the local area network based upon predetermined selection criteria and input decisions from the users of any of the one or more second terminal devices; and
adding an enrollment profile record to the enrollment profile table for each second terminal device for which the enrollment service administers an authentication.

18. The method of using a secure element in a wireless network device of claim 17 wherein the method further comprises:
determining whether any of the one or more second terminal devices has a second memory element containing a second provisioning data field;
retrieving the second provisioning data from the one or more second terminal devices;
administering the second provisioning of the one or more second terminal devices onto the wide area network; and
writing the first provisioning data field from the first memory element to the second memory element in the one or more second terminal devices.

19. The method of using a secure element in a wireless network device of claim 18 wherein the method further comprises verifying the validity of the second provisioning data field of the second terminal device.
